(19) United States
(12) Patent Application Publication
(10) Pub. No.: US 2024/0211735 A1
(43) Pub. Date: Jun. 27, 2024

(54) ERROR-PROOF INFERENCE CALCULATION FOR NEURAL NETWORKS

(71) Applicant: ROBERT BOSCH GMBH, Stuttgart (DE)

(72) Inventors: Christoph SCHORN, Leonberg (DE); Leonardo Luiz ECCO, Stuttgart (DE); Andre GUNTORO, Weil Der Stadt (DE); Jo PLETINCKX, Sersheim (DE); Sebastian VOGEL, Schaidt (DE)

(21) Appl. No.: 17/996,533

(22) PCT Filed: May 25, 2021
(86) PCT No.: PCT/EP2021/063846

§ 371 Date: Oct. 19, 2022

(51) Int. Cl. G06N 3/0464; G06N 5/04

(52) U.S. Cl. CPC G06N 3/0464; G06N 5/04

(57) ABSTRACT

A method for operating a hardware platform for the inference calculation of a convolutional neural network. In the method: an input matrix having input data of the neural network is convolved by the acceleration module with a plurality of convolution kernels, so that a multiplicity of two-dimensional output matrices results; the convolution kernels are summed elementwise to form a control kernel; the input matrix is convolved by the acceleration module with the control kernel, so that a two-dimensional control matrix results; each element of the control matrix is compared with the sum of the elements corresponding thereto in the output matrices; if this comparison yields a deviation for an element of the control matrix, then in response it is checked, with at least one additional control calculation, whether an element of at least one output matrix corresponding to this element of the control matrix was correctly calculated.

### FIELD

The present invention relates to the securing of calculations that are made during the inference operation of neural networks against transient errors on the hardware platform that is used.

### BACKGROUND INFORMATION

In the inference of neural networks, very large numbers of activations of neurons are calculated by summing, in weighted fashion, inputs supplied to these neurons on the basis of weights worked out during the training of the neural network. Thus, a multiplicity of multiplications takes place whose results are subsequently added (multiply-and-accumulate, MAC). In particular in mobile applications, such as the at least partly automated driving of vehicles in roadway traffic, neural networks are implemented on hardware platforms that are specialized for such calculations. These platforms are particularly efficient in computing power with regard to hardware costs and energy consumption per unit. With the increasing integration density of these hardware platforms, the probability of transient, i.e. sporadically occurring, calculation errors increases. Thus, for example the impinging of a high-energy photon from the background radiation on a memory location or processing unit of the hardware platform can randomly “tip” a bit. In addition, in particular in a vehicle the hardware platform shares the electrical network with a multiplicity of further consumers that can couple interference, such as voltage peaks, into the hardware platform. The tolerances in this regard become narrower as the integration density of the hardware platform increases.

German Patent Application No. DE 10 2018 202 095 describes a platform with which, in the processing by a neural network of a tensor of input values to form a tensor of output values, incorrectly calculated output values can be identified using additional control calculations, and can also be corrected.

### SUMMARY

In the context of the present invention, a method is provided for operating a hardware platform for the inference calculation of a convolutional neural network. The hardware platform has at least one acceleration module that is specialized to calculate a convolution of an input matrix with a convolution kernel by applying this convolution kernel to various positions within the input matrix, and to output the result of this convolution as a two-dimensional output matrix. Here, “specialized” is to be understood in particular as meaning for example that the group of tasks that this acceleration module can execute is significantly limited compared to a CPU or GPU of a conventional computer, in exchange for substantially higher performance on these specific tasks. The input matrix and the convolution kernels can here for example be in particular three-dimensional, which is particularly advantageous for the processing of image data. However, they can also be generalized to higher dimensions. Thus, for example in the case of video data or other data that changes over time, three dimensions can represent spatial coordinates and a fourth dimension can represent time.

Very generally, the neural network may thus be developed for example as a classifier for the assignment of observational data, such as for example camera images, thermal images, radar data, lidar data or ultrasonic data, to one or multiple classes of a predefined classification. These classes may represent for example objects or states in the observed area, which are to be detected. The observational data may originate for example from one or multiple sensors, which are installed on a vehicle. From the assignment to classes provided by the neural network, it is then possible for example to derive actions of a driver assistance system or a system for the at least partly automated driving of the vehicle, which fit the concrete traffic situation. The neural network may be for example a convolutional neural network (CNN) divided into layers.

According to an example embodiment of the present invention, in the method, an input matrix having input data of the neural network is convolved by the acceleration module with a plurality of convolution kernels. This means that for each position at which the convolution kernel is applied within the input matrix, the elements covered by the convolution kernel of the input matrix are summed in weighted fashion, the weights being given by the elements of the convolution kernel. The “sampling” of the input matrix by the convolution kernel in two dimensions results in a multiplicity of such weighted sums, which form an output matrix corresponding to the convolution kernel. In the case of a plurality of convolution kernels, a plurality of such output matrices correspondingly result.

The convolution kernels are summed elementwise to form a control kernel. Using the acceleration module, the input matrix is convolved with the control kernel, so that, analogously to the application of the convolution kernels, a two-dimensional control matrix results.

The convolution kernels can, for example, in particular be of the same size. However, this is not necessarily required. If the convolution kernels have different sizes, then they can be for example virtually filled at the edges with zeros up to the size of the largest convolution kernel, in order then to enable the summing of all convolution kernels elementwise to form the control kernel.

Each element of the control matrix is compared to the sum of the corresponding elements in the output matrices. If for example the convolution kernels in the control kernel “sample” the input matrix in each of the dimensions x and y, and have, in the third dimension z, the same depth as the input matrix, then the output matrices corresponding to the convolution kernels, as well as the control matrix, extend along the dimensions x and y, and they are “stacked” in the third dimension z. Then, for each coordinate pair (x, y), the sum of the elements of all output matrices having these coordinates (x, y), i.e. the sum formed along a “column” in the z direction, should be equal to the element of the control matrix having the same coordinates (x, y). This follows from the associative law of mathematics, and can be illustrated by the analogy that, when counting coins, the amount of money should be the same regardless of whether the individual values of the coins are added up directly or whether the coins are first bundled into rolls according to their values, and the values of the rolls are then summed.

If this comparison yields a deviation for an element of the control matrix, then in response at least one additional control calculation is used to check whether an element of at least one output matrix, corresponding to this element of the control matrix, was correctly calculated.

It has been recognized that this organization of the error checking, in connection with the specific named hardware platform, significantly reduces the additional outlay in the form of computing time and memory. By using the same acceleration module for the calculation of the control matrix as for the calculation of the output matrices, this calculation costs very little additional time. Because the goal is to find transient, and thus sporadically occurring, errors, in standard operating environments it is to be expected that there will be no deviation for the large majority (over 99%) of the comparisons. If these cases are processed with maximum efficiency, then, in the case of a deviation, time can be invested in the additional control calculation in order to localize the error more precisely. Here, the specific type of this additional control calculation, as well as the measures taken to remedy precisely located errors, are in principle not limited. Rather, the choice of control calculation, or other measures, can reasonably be guided by how much outlay the calculation, or other measure, costs, and how frequently transient errors are to be expected in the specific application.

If a deviation is found, in principle it may have been caused by incorrect calculation of one or more elements in the output matrices corresponding to the element in the control matrix, and/or by incorrect calculation of the element of the control matrix itself. However, specifically in the case of transient errors, which are what are to be detected in the context of the present invention, the probability is very low that:
two transient errors will occur with a timing such that elements are involved therein that are in two output matrices having a distance from one another in the z direction but that each have the same coordinates (x, y); or that
two transient errors will occur with a timing such that both an element of an output matrix having coordinates (x, y) and the element of the control matrix having the same coordinates (x, y) are involved.

Even if, in such a case, the complete inference calculation has to be repeated because the errors cannot be further localized, due to the low probability this will not result in any loss of efficiency detectable in the specific application. Therefore, for the purposes of further localization and correction of transient errors, one can proceed from the assumption that:
either exactly one element of an output matrix that has the same coordinates (x, y) as the element of the control matrix currently being investigated was incorrectly calculated,
or the element of the control matrix itself was incorrectly calculated.

In, for example, standard hardware platforms used for at least partly automated driving, the occurrence of such individual transient errors is to be expected frequently enough that a complete discarding and repetition of the inference calculation, compared to the further localization and possibly also correction of these errors described below, would mean a detectable slowing of the specific application.

The considerations described above, and all considerations below, are valid regardless of whether the input matrix includes the complete input data of the neural network, or only a part thereof. In many applications, the complete input data of the neural network, and also the complete output matrices generated therefrom, are not processed in the internal buffer (on-chip memory) of the hardware platform, so that the hardware platform processes the data piecewise (in so-called tiles). The results achieved for the individual tiles are then combined in a larger external memory outside the accelerated hardware platform.

According to an example embodiment of the present invention, in the case of convolution with at least one convolution kernel, in addition a bias value corresponding to this convolution kernel can be added to the elements of the output matrix produced with this convolution kernel. The sum of these bias values can then also be added to all elements of the control matrix.

In a particularly advantageous example embodiment of the present invention, the additional control calculation is used to check whether a line or column, containing the element to be checked, of the at least one output matrix was correctly calculated. The acceleration module can also be used for such a check, although it is not primarily intended for this task. If in this way the information is obtained that an element of a particular output matrix (i.e. an element having a particular z coordinate) was not correctly calculated, this permits two inferences to be made. On the one hand, it has then been proven that there is in fact an error in an output matrix, and not for example that merely the calculation of the element of the control matrix is false. On the other hand, the specific output matrix in which the error is located is then also known, i.e. the z coordinate of the error. In connection with the coordinates (x, y) already ascertained in the first comparison, the error has thus then been located at a specific element.

In order to use the acceleration module for this as it were “alien” task, in a particularly advantageous embodiment the input matrix is expanded with verification elements. Each of these verification elements can in particular be, for example, a simple sum of elements from a particular region of the input matrix. The verification elements are convolved by the acceleration module using the convolution kernel corresponding to the at least one output matrix currently being investigated, in order to obtain a control value in this way.

The sum of the elements in the investigated line or column is compared to the control value. If this comparison yields a deviation, then in response it is determined that the line or column was not correctly calculated. This is also a determination that the element originally to be checked of the output matrix was not correctly calculated.

If it is determined that in fact an element of an output matrix has not been correctly calculated, then this element can be corrected by the deviation ascertained in the comparison. As explained above, it is to be assumed that there is only exactly one error. Therefore, both the original comparison with the element of the control matrix and the comparison with the control value will supply the same result.

Because, in accordance with the probability, only a single error is to be reckoned with, the search for further errors can be terminated as soon as a first error has been found. However, it may also occur that all elements corresponding to the element of the control matrix (i.e. the elements having the same coordinates (x, y)) in all output matrices are recognized as correct by the control calculations. It can then be determined that the element of the control matrix was not correctly calculated. That is, the original calculation of the output matrices was correct, and the single transient error to be expected did not occur until the subsequent calculation of the control matrix. Calculation can then continue in normal fashion using the output matrices according to the provided application. The error in the calculation of the control matrix can otherwise be ignored. The above considerations are based on the assumption that there is always only one transient error. An accumulation of errors can however be a signal that these are no longer completely random transient errors, but rather that a hardware component or memory location is beginning to fail. For example, if, in a semiconductor, an interdiffusion takes place due to overheating or aging at a pn transition between a layer doped with holes and a layer doped with electrons, then then the energy input required to tip a bit in the memory may be reduced compared to the normal state, and for example gamma quanta or charged particles from the background radiation may be able, with high probability, to apply this energy input. The errors will then still occur at random times, but they will accumulate more and more in the hardware component or memory cell having the charged pn transition.

Therefore, in a further particularly advantageous example embodiment of the present invention, when one of the comparisons yields a deviation, then with regard to at least one hardware component or at least one memory area that may be the cause of the deviation an error counter is incremented upward in response. The error counters for comparable components can then be compared with one another, for example as part of general maintenance. If one of a plurality of identically constructed hardware components then stands out as having a noticeably increased error counter, this suggests the possibility of a defect in this hardware component.

Thus, in particular for example in response to the determination that the error counter has exceeded a specified threshold value, the hardware component, or the memory area, can be recognized as defective. In response to this, for example the hardware platform can be reconfigured in such a way that for further calculations, instead of the hardware component recognized as defective, or the memory area recognized as defective, a reserve hardware component or reserve memory area can be used. In particular for completely automated driving of vehicles, in which even when there is an error a driver does not take control, it can make sense to provide such reserves. In the case of a defect, the vehicle can then still travel to a repair shop (“limp home mode”), and does not have to be towed, which would be costly.

Advantageously, optical image data, thermal image data, video data, radar data, ultrasonic data, and/or lidar data are provided as input data. These are the most important types of measurement data on the basis of which at least partly self-driving vehicles orient themselves in the traffic space. The measurement data may be obtained through a physical measurement process and/or through a partial or complete simulation of such a measurement process, and/or through a partial or complete simulation of a technical system observable by such a measurement process. For example, it is possible to generate photo-realistic images of situations by a computational tracing of light beams (“ray tracing”) or also by using neural generator networks (for example generative adversarial networks, GAN). For this purpose, it is also possible for example to include findings from the simulation of a technical system, such as for example positions of specific objects, as auxiliary conditions. The generator network may be trained specifically to generate images that satisfy these auxiliary conditions (for example conditional GAN, cGAN).

The output matrices can be processed to form a control signal. Using this control signal, a vehicle and/or a system for quality control of mass-produced products and/or a system for medical imaging and/or an access control system can then be controlled. In this context, the error check described above has the effect that sporadic functional disturbances that come “from nowhere” without a specific cause, and would thus normally be extremely difficult to diagnose, are advantageously avoided.

According to an example embodiment of the present invention, the method can in particular be completely or partially computer-implemented. Therefore, the present invention also relates to a computer program having machine-readable instructions that, when they are executed on one or more computers, cause the computer or computers to carry out one of the described methods. In this sense, control devices for vehicles and embedded systems for technical devices that are also able to execute machine-readable instructions are also to be regarded as computers.

The present invention also relates to a machine-readable data carrier and/or to a download product having the computer program. A download product is a digital product that can be transmitted via a data network, i.e., can be downloaded by a user of the data network, for example offered for immediate download in an online shop.

In addition, a computer can be equipped with the computer program, with the machine-readable data carrier, and/or with the download product.

Further measures that improve the present invention are presented in the following, together with the description of the preferred exemplary embodiments of the present invention, based on Figures.

### BRIEF DESCRIPTION OF THE DRAWINGS

FIG. 1 shows an exemplary embodiment of method 100, according to the present invention.

FIG. 2 shows the rapid ascertaining of a control matrix 5 having a control kernel 4, according to an example embodiment of the present invention.

FIGS. 3A and 3C show the precise localization of an error based on lines (FIG. 3A) or columns (FIG. 3B) 3a #-3c # of the output matrices 3a-3c.

### DETAILED DESCRIPTION OF EXAMPLE EMBODIMENTS

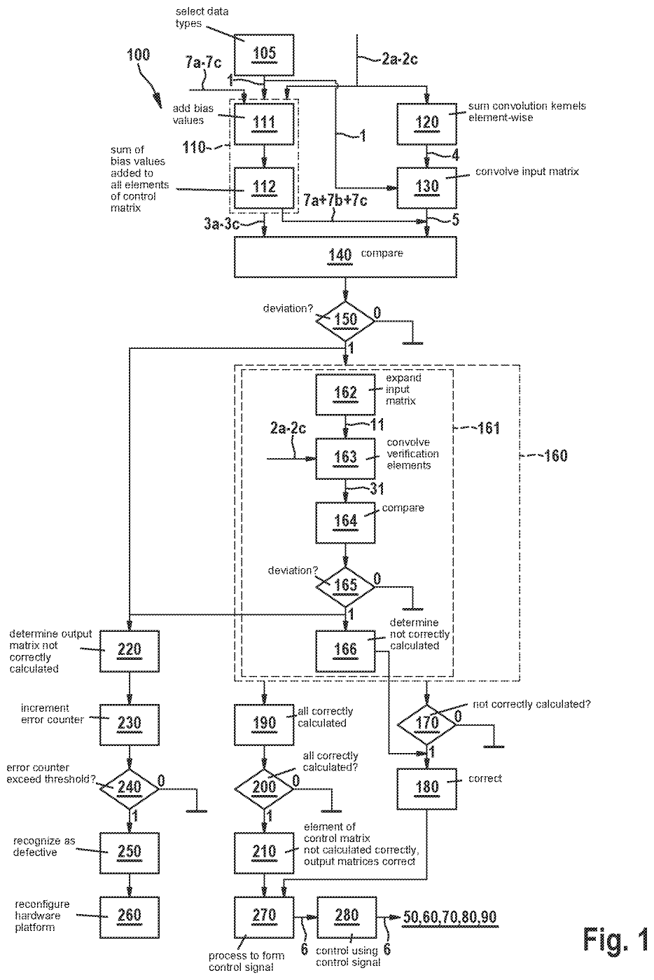

FIG. 1 is a schematic flow diagram of an exemplary embodiment of method 100. According to step 105, those data types that are specifically most important for the orientation of an at least partly automated vehicle in roadway traffic are provided as input data in input matrix 1.

In step 110, input matrix 1, which is three-dimensional in this example, is convolved with the convolution kernels 2a-2c, which are also three-dimensional in this example, in each case producing two-dimensional output matrices 3a-3c. In step 120, convolution kernels 2a-2c are summed elementwise to form a control kernel 4. Input matrix 1 is convolved with control kernel 4, resulting in a two-dimensional control matrix 5. (Step 130.)

In step 140, each element 5* of control matrix 5 is compared with the sum of the corresponding elements 3a*-3c* in output matrices 3a-3c. In step 150, it is checked whether this comparison 140 yields a deviation. If this is the case (probability 1), then in step 160 it is checked whether an element 3a*-3c*, corresponding to this element 5* of control matrix 5, of at least one output matrix 3a-3c was correctly calculated.

If in step 170 it is determined that an element 3a*-3c* of an output matrix 3a-3c was not correctly calculated, this can be corrected in step 180 by the deviation ascertained in the comparison.

However, it is also possible that in step 190, the elements, corresponding to element 5* of control matrix 5, of all output matrices 3a-3c were checked to see if they were correctly calculated, and that in step 200 it was determined that all these elements 3a*-3c* were correctly calculated (probability 1). It is then determined in step 210 that the element 5* of control matrix 5 was not calculated correctly, while at the same time the output matrices 3a-3c are all correct.

If this is the case, or if an error that may have occurred was corrected in step 180, then output matrices 3a-3c are ready for further evaluation. According to step 270, these output matrices 3a-3c can be processed in particular to form a control signal 6. According to step 280, a vehicle 50 and/or a classification system 60 and/or a system 70 for quality control of mass-produced products and/or a system 80 for medical imaging and/or an access control system 90 can then be controlled using this control signal 6.

If, on the other hand, in step 220 it is determined that an output matrix 3a-3c was not calculated correctly, then, according to step 230, with regard to at least one hardware component or at least one memory area that may be the cause of the deviation, an error counter can be incremented upward. If it is then determined in step 240 that the error counter exceeds a specified threshold value (probability 1), then the hardware component or memory area can be recognized as defective in step 250. The hardware platform can then be reconfigured in step 260 in such a way that for further calculations, instead of the hardware component recognized as defective, or the memory area recognized as defective, a reserve hardware component or a reserve memory area is used.

Inside box 110, a possible embodiment of the convolution with convolution kernels 2a-2c is indicated: according to block 111, during the convolution a first bias value 7a is added to the values of first output matrix 3a, a second bias value 7b is added to the values of second output matrix 3b, and a third bias value 7c is added to the values of third output matrix 3c. According to block 112, the sum 7a+7b+7c of these bias values 7a, 7b, 7c is also added to all elements of control matrix 5.

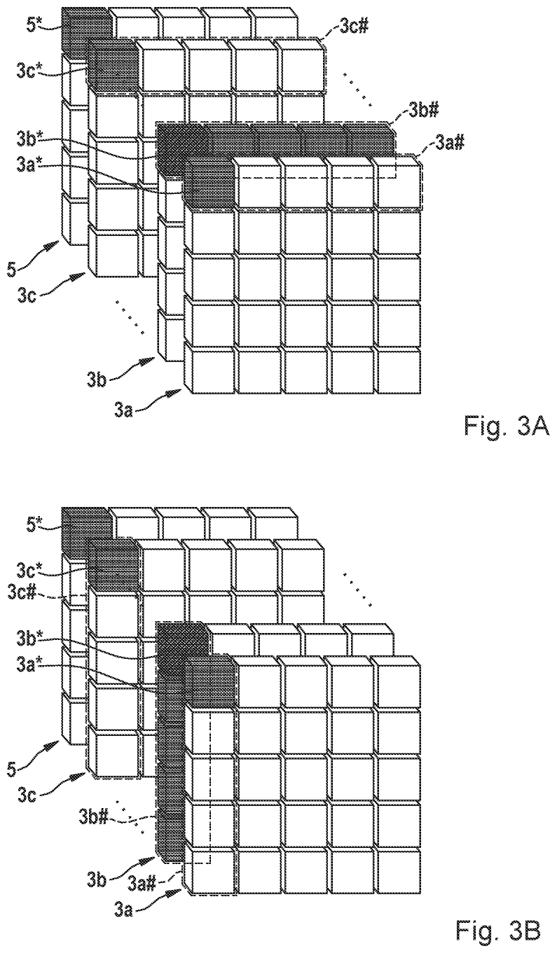

According to block 161, in the additional control calculation 160 it can be checked in particular whether a line or column 3a #-3c #, containing the element 3a*-3c* to be checked, of the at least one output matrix 3a-3c was correctly calculated. This is illustrated in more detail in FIGS. 3A and 3B.

For this check, in particular the accelerator module, provided for the convolving, of the hardware platform can for example be used for an “alien” purpose. For this purpose, according to block 162 input matrix 1 is expanded with verification elements 11. Verification elements 11 are then convolved, according to block 163, by the acceleration module with convolution kernel 2a-2c, which corresponds to the at least one output matrix 3a-3c, in order to thus obtain a control value 31. According to block 164, the sum of the elements in the line or column 3a #-3c # is compared with control value 31. If, in block 165, it is determined that this comparison yields a deviation (probability 1), then in block 166 it is determined that the line or column 3a #-3c# was not correctly calculated, and that the element to be checked 3a*-3c* of the output matrix 3a-3c was thus also not correctly calculated.

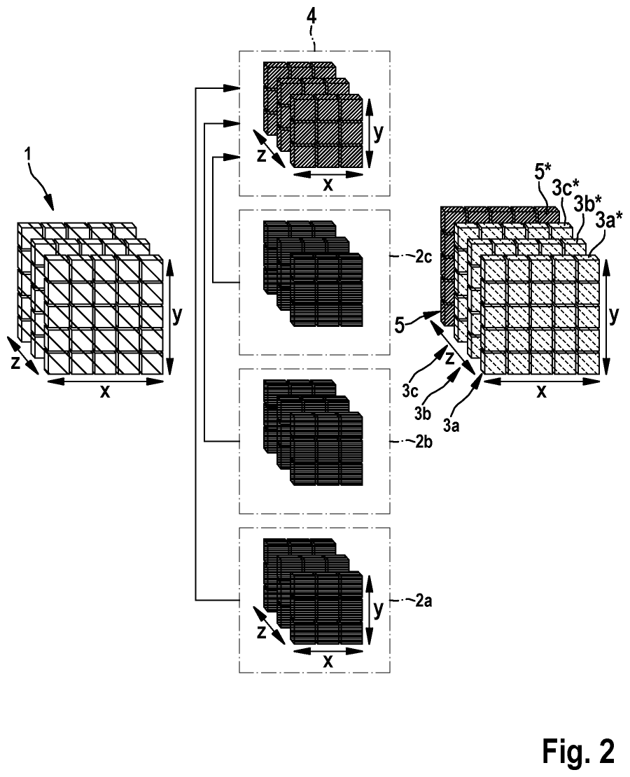

FIG. 2 illustrates how the first check for possible computing errors can be realized particularly efficiently through the use of a control kernel 4 on the hardware platform with the accelerator module. The convolving of input matrix 1 with each of the convolution kernels 2a-2c produces output matrices 3a-3c. Control kernel 4 is formed by summing convolution kernels 2a-2c elementwise. If input tensor 1 is convolved with control kernel 4, a control matrix 5 results that is exactly as large as output matrices 3a-3c. Each element 5* of control matrix 5 should be equal to the sum of the corresponding elements 3a*-3c* of output matrices 3a-3c having the same coordinates (x, y) in the plane of the respective output matrix 3a-3c.

FIGS. 3A and 3B illustrate the further control calculation with which, according to block 161, a possible error can be further localized.

FIG. 3A is based on the assumption that element 5* in the left upper corner of control matrix 5 does not agree with the sum of the corresponding elements 3a*-3c* of output matrices 3a-3c. For each of the output matrices 3a-3c it is thereupon checked whether the respective line 3a #-3c # that contains the corresponding element 3a*-3c* was correctly calculated. As explained above, this can be checked faster than the respective element 3a*-3c* could be individually recalculated.

In the example shown in FIG. 3A, in this control calculation it turns out that line 3b # of output matrix 3b was not correctly calculated. It has thus been determined that element 3b* was not correctly calculated, and a corresponding correction can be carried out.

As FIG. 3B illustrates, the process runs completely analogously when the columns 3a #-3c # of output matrices 3a-3c, containing the respective element to be checked 3a*-3c*, are checked for correct calculation.

1-13. (canceled)

14. A method for operating a hardware platform for an inference calculation of a convolutional neural network, the hardware platform having at least one acceleration module that is specialized to calculate a convolution of an input matrix with a convolution kernel by applying the convolution kernel to various positions within the input matrix, and to output a result of the convolving as a two-dimensional output matrix, the method comprising the following steps:
convolving, by the acceleration module, an input matrix having input data of the neural network with a plurality of convolution kernels, so that a multiplicity of two-dimensional output matrices results;
summing the convolution kernels elementwise to form a control kernel;
convolving, by the acceleration module, the input matrix with the control kernel, so that a two-dimensional control matrix results;
comparing each element of the control matrix with a sum of elements corresponding to the element of the control matrix in the output matrices;
responsive to the comparison yielding a deviation for an element of the control matrix, checking with at least one additional control calculation, whether an element of at least one output matrix corresponding to the element of the control matrix was correctly calculated.

15. The method as recited in claim 14, wherein, in the convolving with at least one of the convolution kernels, a bias value corresponding to the at least one convolution kernel is added to the elements of the output matrix produced with the at least one convolution kernel, and a sum of all bias values is also added to all elements of the control matrix.

16. The method as recited in claim 14, wherein in the checking with the additional control calculation, checking whether a line or a column, containing the element to be checked, of the at least one output matrix was correctly calculated.

17. The method as recited in claim 16, in which, in the additional control calculation:
the input matrix is expanded with verification elements;
the verification elements are convolved, by the acceleration module, with the convolution kernel that corresponds to the at least one output matrix to obtain a control value;
a sum of the elements in the line or the column is compared with the control value; and
responsive to the comparison of the sum of the element in the line or the column with the control value yielding a deviation, determining that the line or the column was not correctly calculated, and the element to be checked of the output matrix was also not correctly calculated.

18. The method as recited in claim 14, wherein in which, in response to the determination that an element of an output matrix was not correctly calculated, the element is corrected by the deviation ascertained in the comparison.

19. The method as recited in claim 14, wherein elements of all of the output matrices corresponding to the element of the control matrix being checked as to whether they were correctly calculated, and, in response to the determination that all of these elements were correctly calculated, determining that the element of the control matrix was not correctly calculated.

20. The method as recited in claim 14, wherein when the comparison yields a deviation with regard to at least one hardware component or at least one memory area that can be regarded as the cause of the deviation, an error counter is incremented upward.

21. The method as recited in claim 20, wherein, in response to a determination that the error counter has exceeded a specified threshold value, the hardware component or the memory area is recognized as defective.

22. The method as recited in claim 21, wherein the hardware platform is reconfigured in such a way that, for further calculations, instead of the hardware component recognized as defective, or the memory area recognized as defective, a reserve hardware component or a reserve memory area is used.

23. The method as recited in claim 14, wherein the input data includes optical image data and/or thermal image data and/or video data and/or radar data and/or ultrasonic data and/or lidar data, the input data having been obtained through a physical measurement process and/or through a partial or complete simulation of the physical measurement process, and/or through a partial or complete simulation of a technical system observable with the physical measurement process.

24. The method as recited in claim 14, further comprising:
processing the output matrices to form a control signal; and
controlling, using the control signal, a vehicle and/or a system for quality control of mass-produced products and/or a system for medical imaging and/or an access control system.

25. A non-transitory machine-readable data carrier on which is stored a computer program for operating a hardware platform for an inference calculation of a convolutional neural network, the hardware platform having at least one acceleration module that is specialized to calculate a convolution of an input matrix with a convolution kernel by applying the convolution kernel to various positions within the input matrix, and to output a result of the convolving as a two-dimensional output matrix, the computer program, when executed by a computer, causing the computer to perform the following steps:
convolving, using the acceleration module, an input matrix having input data of the neural network with a plurality of convolution kernels, so that a multiplicity of two-dimensional output matrices results;
summing the convolution kernels elementwise to form a control kernel;
convolving, using the acceleration module, the input matrix with the control kernel, so that a two-dimensional control matrix results;
comparing each element of the control matrix with a sum of elements corresponding to the element of the control matrix in the output matrices;
responsive to the comparison yielding a deviation for an element of the control matrix, checking with at least one additional control calculation, whether an element of at least one output matrix corresponding to the element of the control matrix was correctly calculated.

26. A computer configured to operate a hardware platform for an inference calculation of a convolutional neural network, the hardware platform having at least one acceleration module that is specialized to calculate a convolution of an input matrix with a convolution kernel by applying the convolution kernel to various positions within the input matrix, and to output a result of the convolving as a two-dimensional output matrix, the computer configured to:
convolve, using the acceleration module, an input matrix having input data of the neural network with a plurality of convolution kernels, so that a multiplicity of two-dimensional output matrices results;
sum the convolution kernels elementwise to form a control kernel;
convolve, using the acceleration module, the input matrix with the control kernel, so that a two-dimensional control matrix results;
compare each element of the control matrix with a sum of elements corresponding to the element of the control matrix in the output matrices;
responsive to the comparison yielding a deviation for an element of the control matrix, checking with at least one additional control calculation, whether an element of at least one output matrix corresponding to the element of the control matrix was correctly calculated.
